(19) United States
(12) Patent Application Publication
(10) Pub. No.: US 2022/0212564 A1
(43) Pub. Date: Jul. 7, 2022

(54) CONTROL DEVICE, CONTROL PROGRAM, AND CONTROL SYSTEM

(71) Applicant: TOYOTA JIDOSHA KABUSHIKI KAISHA, Toyota-shi (JP)

(72) Inventors: Yoshimasa WATANABE, Sunto-gun (JP); Kizuku YAMADA, Susono-shi (JP); Masaki ITO, Toyota-shi (JP); Sakiko YOSHIDA, Mishima-shi (JP); Yuki TAKAHASHI, Susono-shi (JP); Tomonori IMAMURA, Nagoya-shi (JP)

(73) Assignee: TOYOTA JIDOSHA KABUSHIKI KAISHA, Toyota-shi (JP)

(21) Appl. No.: 17/514,263

(22) Filed: Oct. 29, 2021

(30) Foreign Application Priority Data
Jan. 6, 2021 (JP) 2021-001029

(51) Int. Cl. B60L 58/16; B60W 20/20; G06Q 10/02

(52) U.S. Cl. CPC B60L 58/16; G06Q 10/02; B60W 20/20

(57) ABSTRACT

A control device according to the present disclosure is a control device configured to control charging and discharging of the power storage device included in a drive device. The control device includes a processor configured to determine whether the remaining capacity of the power storage device is able to reach the target charging capacity by a disaster occurrence predicted time when disaster information including the predicted time is acquired and is configured to calculate the discharge capacity that is able to be discharged by the predicted time when it is determined that the target charging capacity is able to be reached by the predicted time.

### CROSS-REFERENCE TO RELATED APPLICATION

This application claims priority to Japanese Patent Application No. 2021-001029 filed on Jan. 6, 2021, incorporated herein by reference in its entirety.

### BACKGROUND

### 1. Technical Field

The present disclosure relates to a control device, a control program, and a control system.

### 2. Description of Related Art

Japanese Unexamined Patent Application Publication No. 2016-046975 (JP 2016-046975 A) describes a technique that calculates the target charging capacity according to a risk index that indexes the degree of disaster risk and, based on the calculated target charging capacity, controls the charging and discharging of a battery.

### SUMMARY

However, according to the control described in JP 2016-046975 A, when a disaster is predicted, the discharging of the battery is prohibited and, therefore, the battery cannot be used if the target charging capacity is not reached at the time of calculation.

In view of the foregoing, the present disclosure provides a control device, a control program, and a control system that, when a disaster is predicted, allow the battery to be used effectively until the disaster occurrence predicted time while charging the battery to the target charging capacity by the predicted time.

A first aspect of the present disclosure relates to a control device configured to control the charging and discharging of a power storage device included in a drive device. The control device includes a processor. The processor is configured to determine whether the remaining capacity of the power storage device is able to reach a target charging capacity by a disaster occurrence predicted time when disaster information including the predicted time is acquired. The processor is also configured to calculate a discharge capacity that is able to be discharged by the predicted time when it is determined that the target charging capacity is able to be reached by the predicted time.

A second aspect of the present disclosure relates to a control program. The control program is configured to cause a processor of a control device, configured to control the charging and discharging of a power storage device included in a drive device, to determine whether the remaining capacity of the power storage device is able to reach a target charging capacity by a disaster occurrence predicted time when disaster information including the predicted time is acquired. The control program is also configured to cause the processor of the control device to calculate a discharge capacity that is able to be discharged by the predicted time when it is determined that the target charging capacity is able to be reached by the predicted time.

A third aspect of the present disclosure relates to a control system including a drive device and a control device. The drive device includes a power storage device. The control device includes a processor configured to control the charging and discharging of the power storage device. The processor is configured to determine whether the remaining capacity of the power storage device is able to reach a target charging capacity by a disaster occurrence predicted time when disaster information including the predicted time is acquired. The processor is also configured to calculate a discharge capacity that is able to be discharged by the predicted time when it is determined that the target charging capacity is able to be reached by the predicted time.

According to the present disclosure, when a disaster is predicted, the battery can be used effectively until the disaster occurrence predicted time while charging the battery to the target charging capacity by the predicted time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a control system according to one embodiment;

FIG. 2 is a block diagram showing the configuration of a vehicle included in the control system according to one embodiment;

FIG. 3 is a sequence diagram showing the control processing performed by the control system according to one embodiment;

FIG. 4 is a diagram showing an example of the processing of the control system according to one embodiment;

FIG. 5 is a schematic diagram showing a control system according to a modification; and

FIG. 6 is a sequence diagram showing the control processing performed by the control system according to the modification.

### DETAILED DESCRIPTION OF EMBODIMENTS

Embodiments of the present disclosure will be described below with reference to the drawings. In all the figures of the following embodiments, the same reference numerals will be given to the same or similar components. Note that the present disclosure is not limited to the embodiments described below.

### Embodiments

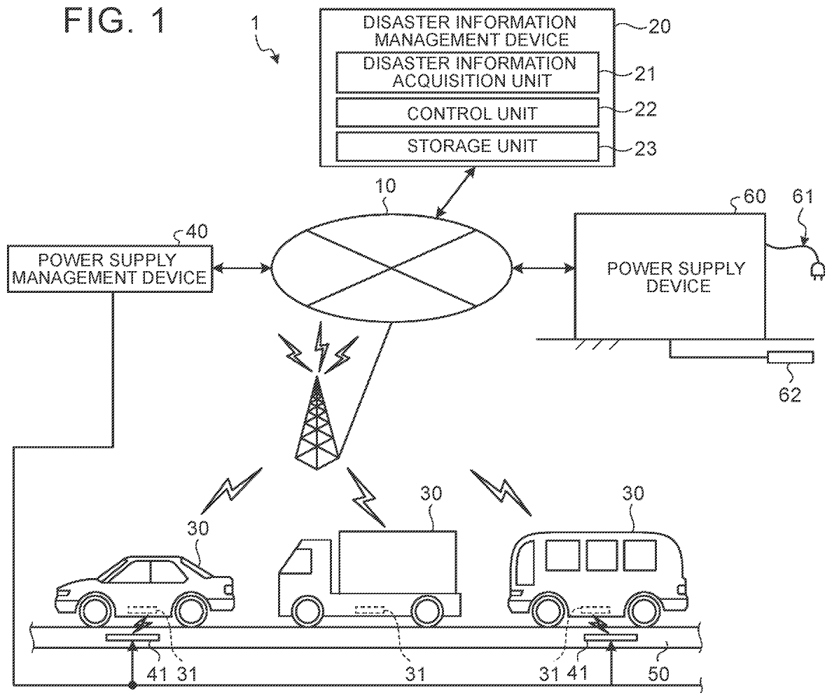

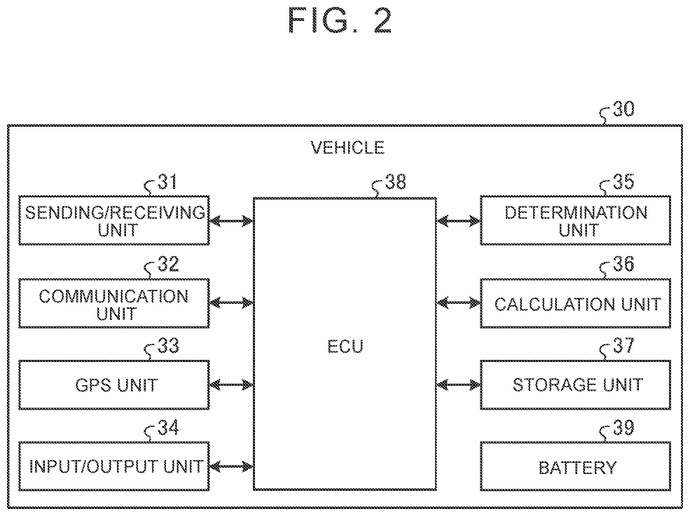

First, a control system according to one embodiment will be described. FIG. 1 is a schematic diagram showing the control system according to one embodiment. FIG. 2 is a block diagram showing the configuration of a vehicle included in the control system according to one embodiment.

A control system 1 includes a disaster information management device 20, vehicles 30, a power supply management device 40, and a power supply device 60. In the control system 1 according to this one embodiment, the disaster information management device 20, the vehicles 30, and the power supply device 60 are connected to each other by a network 10 so that they can communicate with each other. The network 10 is configured by a network, such as the Internet network and a cellular phone network, over which the disaster information management device 20, the vehicles 30, the power supply management device 40, and the power supply device 60 can communicate with each other. In this embodiment, the vehicle 30 is assumed to be an electric vehicle capable of traveling in a hybrid traveling mode or an EV traveling mode.

The disaster information management device 20 sends the information on the power supply control (hereinafter referred to as power supply control information) corresponding to the acquired information on a disaster to the vehicles 30 traveling in the corresponding area.

The disaster information management device 20 includes a disaster information acquisition unit 21, a control unit 22, and a storage unit 23. The disaster information management device 20 is configured by one or more computers each including the components such as a central processing unit (CPU), a field programmable gate array (FPGA), a read only memory (ROM), and a random access memory (RAM).

The disaster information management device 20 connects to the network 10 for communication with the vehicles 30 and the power supply device 60. The disaster information management device 20 receives the information on a disaster (hereinafter, also referred to as disaster information), for example, from the national and/or local government disaster prevention center and sends the information on the control to the vehicles 30. In addition, the disaster information management device 20 may receive the information on the vehicles 30 from the power supply management device 40 or the power supply device 60 and may send various types of information, including the power supply signal, to the vehicles 30 to which the information is to be sent.

The disaster information acquisition unit 21 acquires disaster information acquired from an external source and sends the acquired disaster information to the vehicles 30. The disaster information includes the predicted occurrence time of a disaster that is predicted to occur in the future.

The control unit 22 comprehensively controls the operation of the components of the disaster information management device 20.

The storage unit 23, configured by a computer-readable recording medium, stores various types of programs and various types of data in a writable and readable manner. This recording medium is configured by a storage medium, such as an optical disk, a flash memory, and a magnetic disk, and the drive device for the storage medium.

Next, the configuration of the vehicle 30 will be described with reference to FIG. 1 and FIG. 2. The vehicle 30 has a battery 39 charged by the power supplied by a power supply unit 41 managed by the power supply management device 40 or by the power supplied by the wired power supply unit 61 or the wireless power supply unit 62 managed by the power supply device 60.

The vehicle 30 includes a sending/receiving unit 31, a communication unit 32, a Global Positioning System (GPS) unit 33, an input/output unit 34, a determination unit 35, a calculation unit 36, a storage unit 37, and an electronic control unit (ECU) 38. In addition, the vehicle 30 includes the battery 39 that supplies electric power to the components. The battery 39, a power storage device, is configured to be rechargeable. The parts that control the vehicle 30 are configured by one or more computers each including the components such as a CPU, an FPGA, a ROM, and a RAM.

The sending/receiving unit 31 functions as a receiving unit that receives the power supply signal from the power supply unit 41 or the wireless power supply unit 62. In addition, the sending/receiving unit 31 functions as a sending unit that sends the information on the vehicle 30 to the power supply unit 41 and the power supply device 60 via the electromagnetic wave. Note that the receiving unit and the sending unit, which sends the information on the vehicle 30 to the power supply device 60, may be two separate units instead of being one unit.

The communication unit 32 communicates wirelessly with the external devices via the network 10. The communication unit 32 receives the information on a disaster and the driving assistance information, which assists the driver in driving the vehicle 30, from the disaster information management device 20. The driving assistance information includes the road traffic information such as the information on regulations and traffic jams.

The GPS unit 33 receives radio waves from the GPS satellites to detect the position of the vehicle 30. The detected position is output to the outside, or is stored in the storage unit, of the vehicle 30 as the position information on the vehicle 30.

The input/output unit 34 is configured by a touch panel display, a speaker, a microphone, etc. The input/output unit 34 is configured to display characters and graphics on the screen of the touch panel display, and to output sound from the speaker, under the control of the ECU 38 so that the predetermined information, such as the driving assistance information, can be input and output. In addition, the input/output unit 34 is configured to allow the user of the vehicle 30 to operate the touch panel display, or to speak to the microphone, for inputting the predetermined information to the ECU 38.

The determination unit 35 determines whether the target charging capacity can be reached by a disaster occurrence predicted time based on the current remaining capacity of the battery 39. The remaining capacity is, for example, State Of Charge (SOC).

The calculation unit 36 calculates the dischargeable capacity when the determination unit 35 determines that the remaining capacity will be able to reach the target charging capacity.

The storage unit 37, configured by a computer-readable recording medium, stores various types of programs and various types of data in a writable and readable manner. This recording medium is configured by a storage medium, such as a hard disk, a semiconductor memory, an optical disk, a flash memory, and a magnetic disk, and the drive device for the storage medium. The storage unit 37 stores the programs of the operating system (OS), which is necessary for the ECU 38 to comprehensively control the operation of the units of the vehicle 30, and the programs of various applications.

The ECU 38 is configured by an information processing device such as a microcomputer including the components such as a CPU, an FPGA, a ROM, and a RAM. The ECU 38 comprehensively controls the electrical operation of the components of the vehicle 30. The ECU 38 is configured to perform an operation using data that is received and data and programs that are stored in advance and to output the result of the operation as the control command signal.

The vehicle 30 has a sensor that detects an object approaching from ahead. Furthermore, the vehicle 30 has the control mechanism and the operation mechanism for driving the vehicle 30. More specifically, the vehicle 30 includes the power train and the drive wheels as the drive mechanism. The power train includes the power source and the power transmission mechanism; the power source generates driving force and outputs the generated driving force from the output shaft, and the power transmission mechanism transmits the driving force, output by the power source, to the drive wheels 2. The operation mechanism is configured by the shift lever, the accelerator pedal, and the like. When the vehicle 30 is autonomously driven, each component is driven according to the instruction signal under the control of the ECU 38.

The power supply management device 40 controls the power supply units 41. The power supply units 41, provided in a travel lane 50 in which the vehicle travels, are electrically connected to the power supply management device 40. In this embodiment, each of the power supply units 41 has the detection function for detecting the vehicle 30 located above the power supply unit 41 and the reception function for receiving the information on the vehicle 30. The detection function and the reception function are configured, for example, by a loop antenna. For example, when the vehicle 30 is detected, the detection function sends the detection signal to the power supply management device 40. The power supply coil, if able to detect a vehicle, may be used in common for power supply and detection.

The power supply device 60 includes a wired power supply unit 61 and a wireless power supply unit 62. The power supply device 60 is configured by one or more computers each including the components such as a CPU, an FPGA, a ROM, and a RAM.

The wired power supply unit 61 has a connector for connecting to the vehicle 30. The wired power supply unit 61 sends the power supply signal to the vehicle 30 with the connector connected to the vehicle 30.

The wireless power supply unit 62 sends the power supply signal to the vehicle 30 by wirelessly communicating with the sending/receiving unit 31 of the vehicle 30. When the power supply signal is sent by the wireless power supply unit 62, the vehicle 30 is charged by the power supply device 60 in the non-contact charging mode. The power supply signal is supplied to the vehicle 30 by the communication between the sending/receiving unit 31, provided in the vehicle 30, and the wireless power supply unit 62 provided in the power supply device 60.

In this embodiment, the power supply device 60 has the detection function for detecting the vehicle 30 located above the power supply device 60 and the reception function for receiving the information on the vehicle 30. The detection function and the reception function are configured, for example, by a loop antenna. For example, when the vehicle 30 is detected, the detection function sends the detection signal to the power supply device 60. The power supply coil, if able to detect a vehicle, may be used in common for power supply and detection.

In this embodiment, the battery is charged in the non-contact charging mode between the vehicle 30 and the power supply unit 41 and between the vehicle 30 and the wireless power supply unit 62. The power supply signal is sent to the vehicle 30 by the communication between the sending/receiving unit 31 of the vehicle 30 and the power supply unit 41 or the wireless power supply unit 62. The sending/receiving unit 31, the power supply unit 41, and the wireless power supply unit 62, each configured, for example, by a coil, a switching circuit, and a rectifying smoothing circuit, send and receive the power supply signal by the magnetic field resonance method. This allows non-contact communication between the vehicle 30 and the power supply unit 41. Although power is supplied and information is sent using electromagnetic waves in the example of this embodiment, a configuration is also possible in which power is supplied and information is sent using light.

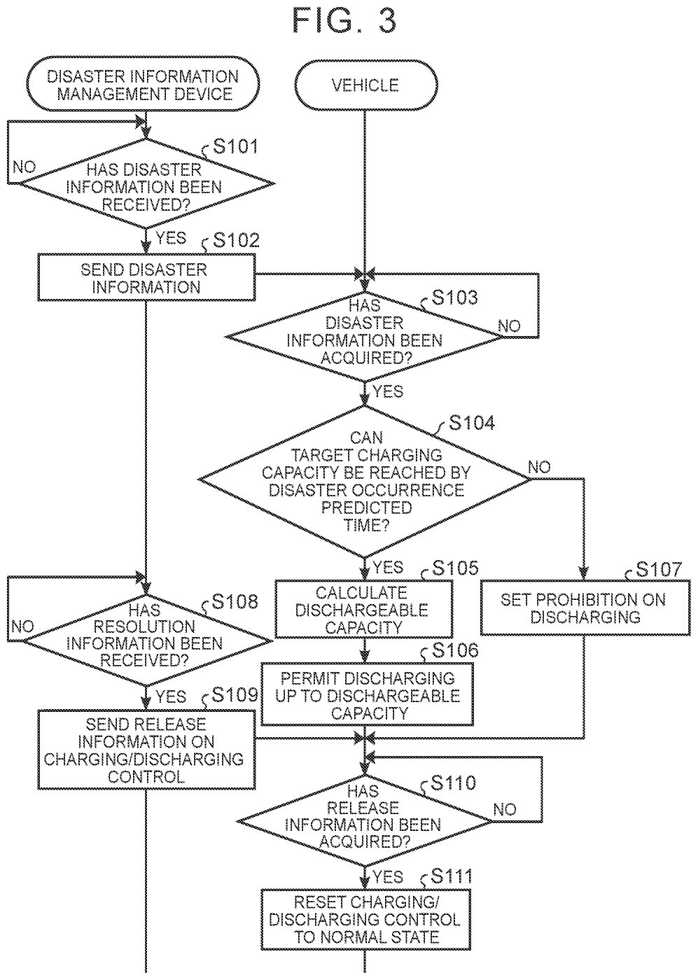

Next, the control processing performed by the control system 1 will be described with reference to FIG. 3. FIG. 3 is a sequence diagram showing the control processing performed by the control system according to the first embodiment.

First, the disaster information acquisition unit 21 determines whether the information on a disaster has been received (step S101). When the disaster information acquisition unit 21 determines that the disaster information has not been received (step S101: No), the reception confirmation is repeated. On the other hand, when the disaster information acquisition unit 21 determines that the disaster information has been received (step S101: Yes), the processing proceeds to step S102.

In step S102, the disaster information acquisition unit 21 sends the disaster information to the vehicles 30 traveling in the corresponding area.

In the vehicle 30, the communication unit 32 determines whether the disaster information has been acquired (step S103). When the power supply control unit 43 has not acquired the disaster information (step S103: No), the acquisition confirmation is repeated. On the other hand, when the power supply control unit 43 determines that the power supply control information has been received (step S103: Yes), the processing proceeds to step S104.

In step S104, the determination unit 35 determines whether the remaining capacity can reach the target charging capacity by the disaster occurrence predicted time, based on the current remaining capacity of the battery 39. At this time, the determination unit 35 determines whether the remaining capacity can reach the target charging capacity based on the preset charging efficiency. The determination unit 35 may determine whether the target charging capacity can be reached based on the charging efficiency of each charging method. When the determination unit 35 determines that the remaining capacity can reach the target charging capacity by the disaster occurrence predicted time (step S104: Yes), the processing of the ECU 38 proceeds to step S105. On the other hand, when the determination unit 35 determines that the remaining capacity cannot reach the target charging capacity by the disaster occurrence predicted time (step S104: No), the processing of the ECU 38 proceeds to step S107.

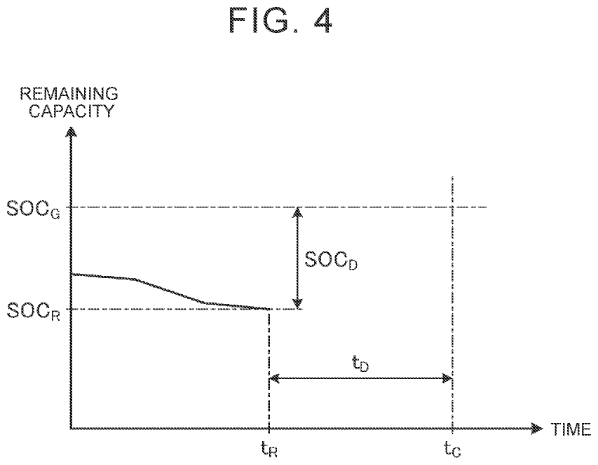

In step S105, when the determination unit 35 determines that the remaining capacity can reach the target charging capacity, the calculation unit 36 calculates the dischargeable capacity. FIG. 4 is a diagram showing an example of the processing of the control system according to one embodiment. FIG. 4 is a diagram showing an example of the relationship between the time and the remaining capacity. In this figure, the time t_{R} is the time of the calculation processing, and SOC_{R} indicates the remaining capacity at the time t_{R}. The time t_{C} is the disaster occurrence predicted time, and SOC_{G} is the target charging capacity. The target charging capacity SOC_{G} is set, for example, to the upper limit of the remaining capacity or to eighty percent of the upper limit.

The calculation unit 36 calculates the shortest time to reach the target charging capacity (this shortest time is called the shortest completion time), for example, based on the current power storage capacity, target charging capacity, and charging efficiency. The calculation unit 36 calculates the difference between the time t_{D}, which is the period of time between the time t_{R} and the time t_{C} (this period of time is called the charging control period t_{D}), and the shortest completion time. This difference corresponds to the time during which the battery may be charged/discharged (this time is called the charging/discharging time). For this charging/discharging time, the calculation unit 36 calculates the dischargeable capacity. This dischargeable capacity is the capacity of power such that, if discharged during the discharging time, the remaining capacity can reach the target charging capacity by charging.

The ECU 38 permits discharging up to the dischargeable capacity calculated by the calculation unit 36 (step S106).

In step S107, the ECU 38 sets a prohibition on discharging. At this time, a message indicating that charging should be started immediately or charging should be continued may be displayed in the vehicle 30 to bring the remaining capacity closer to the target charging capacity.

On the other hand, in the disaster information management device 20, the control unit 22 determines whether the disaster resolution information has been received (step S108). When the control unit 22 determines that the resolution information has not been received (step S108: No), the reception confirmation is repeated. On the other hand, when the control unit 22 determines that the resolution information has been received (step S108: Yes), the processing proceeds to step S109.

In step S109, the control unit 22 sends the release information to the vehicle 30 to release the charging/discharging control activated by the disaster.

The vehicle 30 determines whether the release information has been received (step S110). When the ECU 38 determines that the release information has not been received (step S110: No), the reception confirmation is repeated. On the other hand, when the ECU 38 determines that the release information has been received (step S110: Yes), the processing proceeds to step S111.

In step S111, the ECU 38 resets the charging/discharging control to the normal state and releases the setting of the prohibition on charging/discharging. The normal state mentioned above refers to the state in which a disaster has not occurred or the occurrence of a disaster other than the acquired disaster is not predicted.

In the embodiment described above, when the occurrence of a disaster is predicted, the vehicle 30 determines whether the remaining capacity of the vehicle 30 can reach the target charging capacity by the disaster occurrence predicted time and, based on this determination, controls charging/discharging. According to this embodiment, when the remaining capacity can reach the target charging capacity by the disaster predicted time, charging/discharging is permitted. Therefore, when a disaster is predicted, the battery can be used effectively until the disaster occurrence predicted time while charging the battery to the target charging capacity by the disaster occurrence predicted time.

### Modification

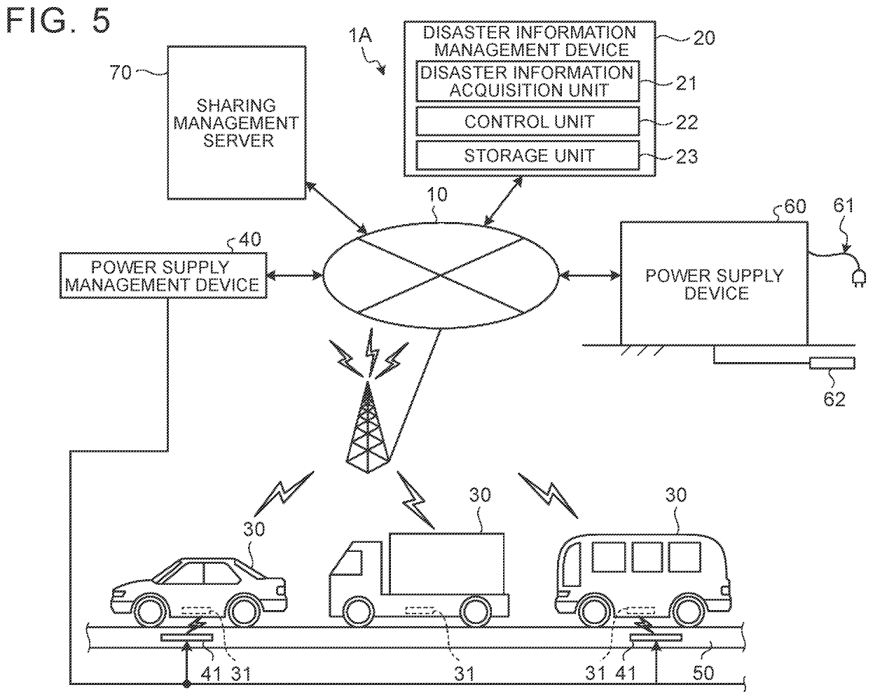

Next, a modification of the embodiment will be described. FIG. 5 is a schematic diagram showing a control system according to the modification. The configuration of a control system 1A according to the modification is different from the configuration of the control system 1 according to the embodiment in that a sharing management server 70 is added. In the description below, the parts different from the embodiment (the configuration of the sharing management server 70 and the processing of the control system 1A) will be described.

The sharing management server 70 manages the vehicles 30, for example, for vehicle sharing. More specifically, the sharing management server 70 accepts a booking for the use of the vehicles 30 and manages the user information. The sharing management server 70 is configured by an information processing device such as a microcomputer composed of a CPU, an FPGA, a ROM, a RAM, etc.

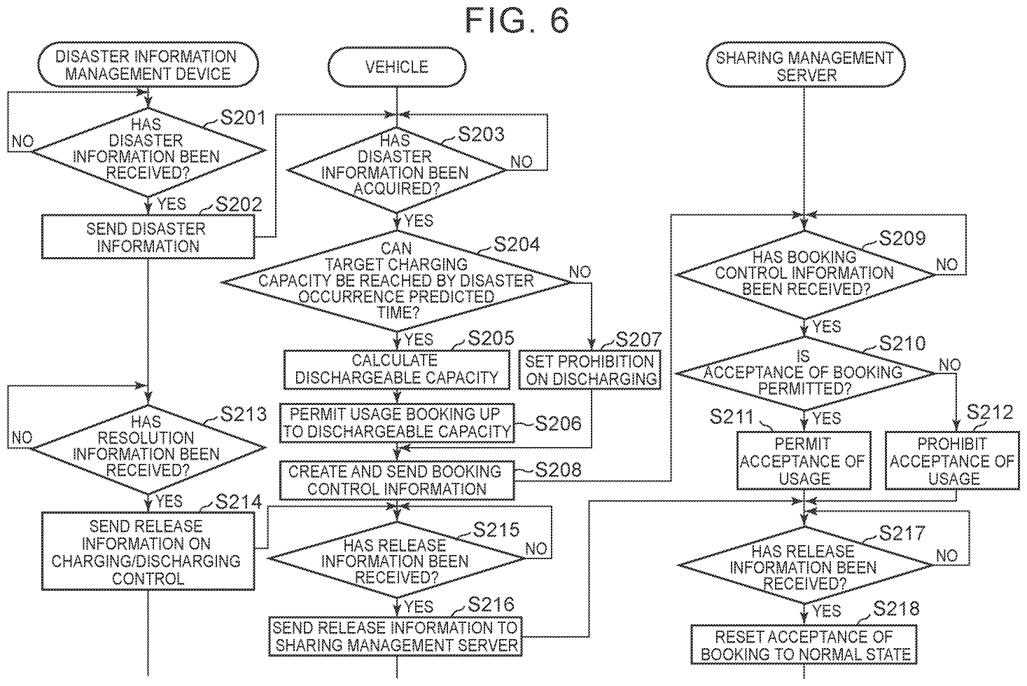

Next, the control processing performed by the control system 1A will be described with reference to FIG. 6. FIG. 6 is a sequence diagram showing the control processing performed by the control system according to the modification.

As in steps S101 to S104 of the flowchart shown in FIG. 3, the disaster information acquisition unit 21 sends the disaster information to the vehicle 30, and the determination unit 35 of the vehicle 30 determines whether the remaining capacity can reach the target charging capacity by the disaster occurrence predicted time based on the current remaining capacity of the battery 39 (steps S201 to S204). When the determination unit 35 determines that the remaining capacity can reach the target charging capacity by the disaster occurrence predicted time (step S204: Yes), the processing of the ECU 38 proceeds to step S205. On the other hand, when the determination unit 35 determines that the remaining capacity cannot reach the target charging capacity by the disaster occurrence predicted time (step S204: No), the processing of the ECU 38 proceeds to step S207.

In step S205, the calculation unit 36 calculates the dischargeable capacity in the same manner as in step S205.

The ECU 38 permits the use of the vehicle 30 up to the dischargeable capacity calculated by the calculation unit 36 (step S206).

On the other hand, in step S207, the ECU 38 sets a prohibition on discharging.

After that, based on the setting in step S206 or S207, the ECU 38 creates booking control information and sends the created booking control information to the sharing management server 70 (step S208).

The sharing management server 70 determines whether the booking control information has been received from the vehicle 30 (step S209). When the sharing management server 70 determines that the booking control information has not been received (step S209: No), the reception confirmation is repeated. On the other hand, when the sharing management server 70 determines that the booking control information has been received (step S209: Yes), the processing proceeds to step S210.

In step S210, the sharing management server 70 refers to the booking control information and determines whether the vehicle 30, which has sent the booking control information, permits the acceptance of a booking. When the sharing management server 70 determines that the vehicle 30 permits the acceptance of a booking (step S210: Yes), the processing proceeds to step S211. On the other hand, when the sharing management server 70 determines that the vehicle 30 does not permit the acceptance of a booking (step S210: No), the processing proceeds to step S212.

In step S211, the sharing management server 70 permits the acceptance of a booking for the vehicle 30 that has sent the booking control information.

In step S212, the sharing management server 70 prohibits the acceptance of a booking for the vehicle 30 that has sent the booking control information. As a result, the acceptance of a booking for the vehicle 30 that has sent the booking control information is stopped.

On the other hand, in the disaster information management device 20, the control unit 22 determines whether the disaster resolution information has been received (step S213). When the control unit 22 determines that the resolution information has not been received (step S213: No), the reception confirmation is repeated. On the other hand, when the control unit 22 determines that the resolution information has been received (step S213: Yes), the processing proceeds to step S214.

In step S214, the control unit 22 sends the release information, which releases the charging/discharging control activated by a disaster (in this case, the control whether to permit a booking), to the vehicle 30.

The vehicle 30 determines whether the release information has been received (step S215). When the ECU 38 determines that the release information has not been received (step S215: No), the reception confirmation is repeated. On the other hand, when the ECU 38 determines that the release information has been received (step S215: Yes), the processing proceeds to step S216.

In step S216, the ECU 38 sends the release information to the sharing management server 70. Note that, in step S214, the disaster information management device 20 may send the release information directly to the sharing management server 700.

The sharing management server 70 determines whether the release information has been received from the vehicle 30 (step S217). When the sharing management server 70 determines that the release information has not been received (step S217: No), the reception confirmation is repeated. On the other hand, when the sharing management server 70 determines that the release information has been received (step S217: Yes), the processing proceeds to step S218.

In step S218, the sharing management server 70 resets the usage booking to the normal state. That is, the sharing management server 70 accepts a booking for the use of the vehicle 30 regardless of the remaining capacity.

In the modification described above, when the occurrence of a disaster is predicted, the vehicle 30 determines whether the remaining capacity of the vehicle can reach the target charging capacity by the disaster occurrence predicted time and, based on this determination, controls the charging/discharging of the vehicle 30 that is used for vehicle sharing. According to this modification, when the remaining capacity can reach the target charging capacity by the disaster predicted time, charging/discharging is permitted. Therefore, when a disaster is predicted, the battery can be used effectively until the disaster occurrence predicted time while charging the battery to the target charging capacity by the predicted time.

In the modification, though the sequence diagram in FIG. 6 shows an example in which the sharing management server 70 controls a booking for the use of the vehicles 30 that are managed in this system, each of the vehicles 30 may individually set the permission and prohibition of the use.

In the embodiment and the modification described above, though examples have been described in which the processing is performed for an electric vehicle equipped with a power storage device, the present disclosure is not limited to a moving body, such as an electric vehicle, that is equipped with a power storage device. The present disclosure may also be applied to a drive device, such as a generator or a radio equipped with a power storage device, that is equipped with a power storage device and is required to have the remaining capacity satisfying the target charging capacity at the time of a disaster.

### Recording Medium

In one embodiment, a program capable of executing the processing method provided by the power supply control system can be recorded on a recording medium readable by a computer or any other machine or device (hereinafter, referred to as a computer or the like). By causing the computer or the like to read the program from this recording medium for execution, the computer or the like functions as the control unit of each of the devices of the power supply control system. The above-mentioned recording medium readable by the computer or the like refers to a non-transitory recording medium in which the information, such as data or programs, is stored by an electrical, magnetic, optical, mechanical, or chemical action and from which the computer or the like can read the information. Among these recording media, the recording media removable from the computer or the like include a flexible disk, a magneto-optical disk, a CD-ROM, a CD-R/W, a digital versatile disk (DVD), a BD, a DAT, a magnetic tape, and memory cards such as a flash memory. The recording media permanently installed in the computer or the like include a hard disk drive and a ROM. Furthermore, an SSD can be used as a recording medium removable from the computer or the like or as a recording medium permanently installed in the computer or the like.

### Other Embodiments

In description of the control system according to one embodiment, “unit” can be read as “circuit” or the like. For example, the communication unit can be read as a communication circuit.

A program to be executed by each device of the control system according to the embodiment may be provided by storing it on a computer connected to a network, such as the Internet, for allowing the user to download it via the network.

Further effects and modifications can be easily derived by those skilled in the art. The broader aspects of the present disclosure are not limited to the specific details and typical embodiments expressed and described above. Accordingly, various modifications can be made without departing from the spirit or scope of the general inventive concept as defined by the appended claims and their equivalents.

What is claimed is:

1. A control device configured to control charging and discharging of a power storage device included in a drive device, the control device comprising:
a processor configured to determine whether a remaining capacity of the power storage device is able to reach a target charging capacity by a disaster occurrence predicted time when disaster information including the predicted time is acquired and configured to calculate a discharge capacity that is able to be discharged by the predicted time when it is determined that the target charging capacity is able to be reached by the predicted time.

2. The control device according to claim 1, wherein the processor is configured to control the drive device based on the calculated discharge capacity.

3. The control device according to claim 1, wherein the processor is configured to permit the drive device to discharge power equal to or lower than the discharge capacity.

4. The control device according to claim 1, wherein the processor is configured to prohibit a use of the power storage device when it is determined that the target charging capacity is not able to be reached by the predicted time.

5. The control device according to claim 1, wherein:
the drive device is an electric vehicle; and
the processor is configured to permit a use of the electric vehicle within a discharge range of equal to or lower than the discharge capacity.

6. The control device according to claim 1, wherein the processor is configured to calculate the discharge capacity based on a charging efficiency according to a class of a power supply device that supplies power to the power storage device.

7. A control program configured to cause a processor of a control device, configured to control charging and discharging of a power storage device included in a drive device, to determine whether a remaining capacity of the power storage device is able to reach a target charging capacity by a disaster occurrence predicted time when disaster information including the predicted time is acquired and to calculate a discharge capacity that is able to be discharged by the predicted time when it is determined that the target charging capacity is able to be reached by the predicted time.

8. The control program according to claim 7, wherein the control program is configured to cause the processor to control the drive device based on the calculated discharge capacity.

9. The control program according to claim 7, wherein the control program is configured to cause the processor to permit the drive device to discharge power equal to or lower than the discharge capacity.

10. The control program according to claim 7, wherein the control program is configured to cause the processor to prohibit a use of the power storage device when it is determined that the target charging capacity is not able to be reached by the predicted time.

11. The control program according to claim 7, wherein:
the drive device is an electric vehicle; and
the control program is configured to cause the processor to permit a use of the electric vehicle within a discharge range of equal to or lower than the discharge capacity.

12. The control program according to claim 7, wherein the control program is configured to cause the processor to calculate the discharge capacity based on a charging efficiency according to a class of a power supply device that supplies power to the power storage device.

13. A control system comprising:
a drive device including a power storage device; and
a control device including a processor configured to control charging and discharging of the power storage device, wherein the processor is configured to determine whether a remaining capacity of the power storage device is able to reach a target charging capacity by a disaster occurrence predicted time when disaster information including the predicted time is acquired and is configured to calculate a discharge capacity that is able to be discharged by the predicted time when it is determined that the target charging capacity is able to be reached by the predicted time.

14. The control system according to claim 13, wherein the processor is configured to control the drive device based on the calculated discharge capacity.

15. The control system according to claim 13, wherein the processor is configured to permit the drive device to discharge power equal to or lower than the discharge capacity.

16. The control system according to claim 13, wherein the processor is configured to prohibit a use of the power storage device when it is determined that the target charging capacity is not able to be reached by the predicted time.

17. The control system according to claim 13, wherein:
the drive device is an electric vehicle; and
the processor is configured to permit a use of the electric vehicle within a discharge range of equal to or lower than the discharge capacity.

18. The control system according to claim 17, the control system further comprising a management server including a second processor configured to manage a booking for a use of the electric vehicle, wherein the second processor is configured to accept a booking for a use of the electric vehicle when the processor of the control device permits the use of the electric vehicle.

19. The control system according to claim 18, wherein the second processor is configured to stop a booking for the use of the electric vehicle when the processor of the control device determines that the target charging capacity is not able to be reached by the predicted time and prohibits the use of the power storage device.

20. The control system according to claim 13, wherein the processor is configured to calculate the discharge capacity based on a charging efficiency according to a class of a power supply device that supplies power to the power storage device.
